(19) United States
(12) Patent Application Publication
(10) Pub. No.: US 2025/0232756 A1
(43) Pub. Date: Jul. 17, 2025

(54) HOWLING SUPPRESSION SYSTEM, METHOD FOR AN ANC/PSAP SYSTEM AND STORAGE MEDIUM

(71) Applicant: Bestechnic (Shanghai) Co., Ltd., Shanghai (CN)

(72) Inventors: Qian LI, Shanghai (CN); Si XU, Shanghai (CN)

(73) Assignee: Bestechnic (Shanghai) Co., Ltd., Shanghai (CN)

(21) Appl. No.: 19/096,862

(22) Filed: Apr. 1, 2025

Related U.S. Application Data
(63) Continuation of application No. PCT/CN2023/103751, filed on Jun. 29, 2023.

(30) Foreign Application Priority Data
Oct. 10, 2022 (CN) 202211234529.0

(51) Int. Cl. G10K 11/178

(52) U.S. Cl. CPC G10K 11/17854; G10K 2210/3028; G10K 2210/506

(57) ABSTRACT

A howling suppression system comprises a system on chip. The system on chip is configured to via an adaptive notch filter, adaptively adjust to a notch frequency point in steps, and perform a first notch filtering on energy corresponding to the notch frequency point adjusted to; via a processor, obtain a mean and a variance of a notch parameter of the adaptive notch filter associated with the notch frequency point, and determine that the adaptive notch filter is in a convergence state and the notch frequency point is a howling frequency when the mean of the notch parameter is within a preset range and the variance is less than a first threshold; when the adaptive notch filter is in the convergence state, use the audio signal with the howling frequency point having been notch-filtered by the adaptive notch filter as an output of the howling suppression system.

### CROSS-REFERENCE TO RELATED APPLICATIONS

This application is a continuation of International Application No. PCT/CN2023/103751, filed on Jun. 29, 2023, which claims the benefit of priority to Chinese Application No. 202211234529.0, filed on Oct. 10, 2022, both of which are hereby incorporated by reference in their entireties.

### TECHNICAL FIELD

The present application relates to the field of audio processing, and more specifically, to a howling suppression system, method for an active noise control/personal sound amplification product (ANC/PSAP) system and a storage medium.

### BACKGROUND

With the development of technology, active noise reduction headphones and personal sound amplifiers have been widely used. However, when active noise reduction technology and personal sound amplification technology are applied to headphone products, cancellation signals or compensation signals with opposite phases are often generated to achieve noise reduction or hearing aid effect. In these scenarios, when the cancellation/hearing aid signal generated by the ANC/PSAP system is played by a speaker, it will be picked up by a microphone, and the sound path will form a closed loop. The signal is continuously superimposed and amplified in the sound feedback loop to form positive feedback, generating howling. However, when the adaptive echo cancellation technology is applied in the ANC/PSAP system, it has a high computational complexity, cannot be implemented in hardware, and has a poor suppression effect, which seriously affects the user experience.

### SUMMARY

The present application is provided to solve the above problem existing in the prior art. A howling suppression system, method for an ANC/PSAP system and a storage medium are needed, which are easy to be implemented in hardware at a high sampling rate and can improve the howling suppression effect to improve the user experience.

According to a first scheme of the present application, a howling suppression system for an ANC/PSAP system is provided. The howling suppression system comprises a system on chip. The system on chip is configured to comprise: at least one howling suppression unit, each of the at least one howling suppression unit comprising at least an adaptive notch filter, the adaptive notch filter adaptively adjusting to a notch frequency point in steps; in an input audio signal of the ANC/PSAP system, a first notch filtering being performed on energy corresponding to the notch frequency point adjusted to. A processor configured to: obtain a mean and a variance of a notch parameter of the adaptive notch filter associated with the notch frequency point, and determine that the adaptive notch filter is in a convergence state and the notch frequency point is a howling frequency point when the mean of the notch parameter is within a preset range and the variance is less than a first threshold; determine that the adaptive notch filter is in a non-convergence state or there is no howling frequency point when the mean of the notch parameter is not within the preset range and/or the variance is greater than a second threshold. When the adaptive notch filter is in the convergence state, the audio signal with the howling frequency point having been notch-filtered by the adaptive notch filter is used as an output of the howling suppression system. When the adaptive notch filter is in the non-convergence state or there is no howling frequency point, the input audio signal is used as the output of the howling suppression system.

According to a second scheme of the present application, a howling suppression method for an ANC/PSAP system is provided, comprising: adaptively adjusting to a notch frequency point in steps via an adaptive notch filter; in an input audio signal of the ANC/PSAP system, performing a first notch filtering on energy corresponding to the notch frequency point adjusted to; obtaining, via a processor, a mean and a variance of a notch parameter of the adaptive notch filter associated with the notch frequency point, and determining that the adaptive notch filter is in a convergence state and the notch frequency point is a howling frequency point when the mean of the notch parameter is within a preset range and the variance is less than a first threshold; determining that the adaptive notch filter is in a non-convergence state or there is no howling frequency point when the mean of the notch parameter is not within the preset range and/or the variance is greater than a second threshold; using the audio signal with the howling frequency point having been notch-filtered by the adaptive notch filter as an output of the howling suppression system when the adaptive notch filter is in the convergence state; using the input audio signal as the output of the howling suppression system when the adaptive notch filter is in the non-convergence state or there is no howling frequency point.

Compared with the prior art, the beneficial effects of the embodiments of the present application include the following.

The adaptive notch filter is used to perform notch filtering on the energy corresponding to the notch frequency point, which has low computational complexity and low cost, and can realize hardware implementation at a high sampling rate. By determining whether the notch frequency point is in a convergence state, it is determined whether the notch frequency point is a howling frequency point. When the adaptive notch filter is in the convergence state, the audio signal with the howling frequency point having been notch-filtered by the adaptive notch filter as the output of the howling suppression system, and when the adaptive notch filter is in a non-convergence state or there is no howling frequency point, the input audio signal is used as the output of the howling suppression system. In this way, the howling frequency point can be efficiently suppressed without reducing the gain. At the same time, the use of the adaptive notch filter for notch filtering can reduce the time consumed by the determination of howling frequency point, thereby reducing the delay of the entire howling suppression system in processing the howling frequency point. For example, the transparency mode has a higher requirement for hardware and requires a lower latency for howling suppression. In this way, it is conducive to the fusion of external audio and sound from the headphones in the transparency mode, which can not only improve the howling suppression effect, but also improve the user experience.

The above description is only an overview of the technical solutions of the present application. In order to more clearly understand the technical means of the present application, it can be implemented in accordance with the contents of the specification. In order to make the above and other purposes, features and advantages of the present application more clear and easy to understand, the detailed description of the present application are listed below.

### BRIEF DESCRIPTION OF THE DRAWINGS

In the drawings that are not necessarily drawn to scale, the same reference numerals may describe similar components in different views. The drawings generally illustrate various embodiments by way of example and not by way of limitation, and together with the specification and claims, are used to illustrate the disclosed embodiments. When appropriate, the same reference numerals are used in all drawings to refer to the same or similar parts. Such embodiments are illustrative and are not intended to be exhaustive or exclusive embodiments of the present device or method.

FIG. 1(a) illustrates a structural schematic diagram of a howling suppression system for an ANC/PSAP system according to an embodiment of the present application.

FIG. 1(b) illustrates a flow chart of a method for howling suppression by a howling suppression system for an ANC/PSAP system according to an embodiment of the present application.

FIG. 2 illustrates a schematic diagram of a PSAP system using the howling suppression system of an embodiment of the present application.

FIG. 3 illustrates a schematic diagram of an ANC system using the howling suppression system of an embodiment of the present application.

### DETAILED DESCRIPTION

In order to enable those skilled in the art to better understand the technical solutions of the present application, the present application is described in detail below in conjunction with the accompanying drawings and specific implementations. The embodiments of the present application are further described in detail below in conjunction with the accompanying drawings and specific implementations, but are not intended to limit the present application. If there is no necessity for the chronological relationship among the steps described herein, the order in which the steps are described as examples herein should not be regarded as a limitation. Those skilled in the art should know that the order can be adjusted as long as no logic between them is destroyed, causing the entire process cannot be implemented.

The words “first”, “second” and similar words used in the present application do not indicate any order, quantity or importance, but are only used to distinguish one from another. Words such as “include” or “contain” or the like mean that the elements before the word include the elements listed after the word, and do not exclude the possibility of covering other elements. In the present application, the arrows of each step shown in the figures are only examples of the execution order, but not limitations. The technical solutions of the present application are not limited to the execution order described in the embodiments. The steps in the execution order can be combined, decomposed, or changed in order, as long as the logical relationship of the execution content is not affected.

All terms (including technical terms or scientific terms) used in the present application, unless otherwise specifically defined, have the same meaning as understood by those of ordinary skill in the art. It should also be understood that terms defined in general dictionaries should be interpreted as having meanings consistent with their meanings in the context of the relevant technology, and should not be interpreted in an idealized or extremely formal sense, unless explicitly defined here. The techniques, methods and devices known to those of ordinary skill in the art may not be discussed in detail, but where appropriate, the techniques, methods and devices should be considered as part of the specification.

According to an embodiment of the present application, a howling suppression system for an ANC/PSAP system is provided. The howling suppression system includes a system on a chip. The system on a chip includes at least one howling suppression unit and a processor. The howling suppression unit and the processor perform corresponding steps in a howling suppression method for the ANC/PSAP system according to each embodiment of the present application.

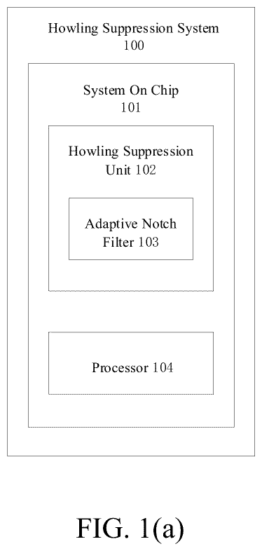

FIG. 1 (a) illustrates a structural schematic diagram of a howling suppression system for an ANC/PSAP system according to an embodiment of the present application. FIG. 1 (b) illustrates a flow chart of a method for howling suppression by a howling suppression system for an ANC/PSAP system according to an embodiment of the present application. Wherein, “/” in ANC/PSAP means “or”, so as to indicate that the howling suppression system 100 described in the present application can be used in an ANC (Active Noise Control) system or a PSAP (Personal Sound Amplification Product) system. The howling suppression system 100 includes a system on chip 101, and the method for suppressing howling based on the howling suppression system 100 can be implemented by the system on chip 101.

Please note that in the present application, various components, such as a howling suppression unit 102, an adaptive notch filter 103, a processor 104, etc., as shown in FIG. 1 (a), can be implemented by a SOC (system on chip), for example, being implemented as the system on chip 101. For example, various RISC (Reduced Instruction Set Computer) processor IPs purchased from companies such as ARM and the like can be used as the processor 104 of the SOC to perform corresponding functions, so that it can be implemented as an embedded system. Specifically, there are many modules on the modules (IP) available on the market, such as, but not limited to, memory, cache, etc. In some embodiments, chip manufacturers can also independently develop customized versions of these modules on the ready-made IP. In addition, others such as limiters, speakers, microphones, etc. can be externally connected to the IP. Users can build an ASIC (Application Specific Integrated Circuit) based on purchased IPs or self-developed modules, to build the howling suppression system 100 to reduce power consumption and cost.

The embodiment of the present application adopts the adaptive notch filter 103 for adaptive notch filtering. Compared with the general howling suppression and adaptive echo cancellation solutions used on hearing aids with lower delay performance requirement, it has lower complexity and is easy to implement in hardware at a high sampling rate. For example, the howling suppression system 100 can use a hardware entity module to achieve howling suppression. Taking a Programmable Logic Device (PLD) as an example, its logic function is determined by the user programming the device. A digital system is “integrated” on a PLD by the designer himself programming, without the need to ask a chip manufacturer to design and produce a dedicated integrated circuit chip. This programming can also be implemented using a “logic compiler” software. The original codes before compilation are written in a specific programming language, which is called as a Hardware Description Language (HDL). There is not only one type of HDL, but many types, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. Those skilled in the art should also be aware that the hardware circuit that implements the logic method process can be easily obtained by only slightly logic programming the howling suppression process with the above-mentioned Hardware Description Languages and programming it into the integrated circuit.

The system on chip 101 is configured to include at least one howling suppression unit 102. Each howling suppression unit of the at least one howling suppression unit 102 includes at least an adaptive notch filter 103. As shown in FIG. 1(b), in step S101, the adaptive notch filter 103 adaptively adjusts to the notch frequency point in steps. In step S102, in the input audio signal of the ANC/PSAP system, a first notch filtering of the energy corresponding to the notch frequency point adjusted to is performed. That is, the adaptive notch filter 103 uses the notch frequency point adjusted to as the estimated howling frequency point, and performs notch filtering on the energy corresponding to the frequency point in the input audio signal of the ANC/PSAP system.

The system on chip 101 also includes a processor 104, which may be a processing device including more than one general processing device, such as a microprocessor, a central processing unit (CPU), a graphics processing unit (GPU), etc. More specifically, the processor 104 may be a complex instruction set computing (CISC) microprocessor, a reduced instruction set computing (RISC) microprocessor, a very long instruction word (VLIW) microprocessor, a processor running other instruction sets, or a processor running a combination of instruction sets. The processor 104 may also be more than one dedicated processing device, such as an application-specific integrated circuit (ASIC), a field programmable gate array (FPGA), a digital signal processor (DSP), a system on chip (SoC), etc. The processor 104 may be included in the howling suppression unit 102, or may be arranged outside the howling suppression unit 102 and cooperate with the howling suppression unit 102 to perform the howling suppression function, thereby forming the howling suppression system 100.

The processor 104 is configured to perform steps S103-S109 to determine the convergence state of the adaptive notch filter 103. In step S103, a mean and a variance of a notch parameter of the adaptive notch filter 103 associated with the notch frequency point are obtained, and then it is determined whether the mean of the notch parameter is within a preset range (step S104). If no, step S106 is performed to determine that the adaptive notch filter 103 is in a non-convergence state or there is no howling frequency point. If the result of the determination in step S104 is “yes”, then step S105 is performed to further determine whether the variance of the notch parameter is less than a first threshold. If yes, step S108 is performed to determine that the adaptive notch filter 103 is in a convergence state and the notch frequency point is a howling frequency point. If the result of the determination in step S105 is “no”, it is further determined whether the variance of the notch parameter is greater than a second threshold (step S107). If yes, step S106 is performed to determine that the adaptive notch filter 103 is in the non-convergence state or there is no howling frequency point. If no, step S109 is performed, and the output path remains unchanged. By remaining the output path unchanged, it can achieve a hysteresis effect, so that before the adaptive notch filter 103 stabilizes, the number of times of switching the system output path is reduced. Wherein the specific values of the first threshold and the second threshold are not limited, and can be manually set or can be system default values. That is to say, when the mean of the notch parameter is within the preset range and the variance is less than the first threshold, it is determined that the adaptive notch filter 103 is in the convergence state and the notch frequency point is a howling frequency point. Wherein, the specific values in the preset range of the notch parameter are not limited. For example, it can be determined in association with the howling frequency that is prone to howling. When the mean of the notch parameter is not within the preset range, and/or the variance is greater than the second threshold, it is determined that the adaptive notch filter 103 is in the non-convergence state or there is no howling frequency point.

Further, when the processor 104 determines that the adaptive notch filter 103 is in the convergence state, it means that the notch frequency point to which the adaptive notch filter 103 currently adaptively adjusts is the howling frequency point of the ANC/PSAP system and needs to be suppressed. At this time, step S110 is performed to use the audio signal with the howling frequency point having been notch-filtered by the adaptive notch filter 103 as the output of the howling suppression system 100. Therefore, the processor 104 determines whether the adaptive notch filter 103 is in the convergence state during the notch filtering of the adaptive notch filter 103, and only when it is determined that the adaptive notch filter 103 has converged to the howling frequency point, the audio signal that has been notch-filtered by the adaptive notch filter 103 is used as the output of the howling suppression system 100, so as to achieve the purpose of effectively suppressing the energy of the howling frequency point when howling does occur. When the processor 104 determines that the adaptive notch filter 103 is in the non-convergence state, or when no howling occurs in the ANC/PSAP system and therefore there is no howling frequency point, step S111 is performed to use the input audio signal that has not been notch-filtered as the output of the howling suppression system 100. When the processor 104 determines that the adaptive notch filter 103 is not in the convergence state, it means that the adaptive notch filter 103 has not yet completed the adaptive adjustment in steps of the notch frequency point, or that currently no howling occurs in the ANC/PSAP system. At this time, directly using the input audio signal as the output directly can avoid erroneous or unnecessary suppression of useful signals at non-howling frequencies.

According to the howling suppression system 100 of the embodiments of the present application, by determining the convergence state of the adaptive notch filter 103, inappropriate notch filtering of the input signal when no howling occurs in the system, thereby causing distortion of the output signal, can be avoided. Moreover, compared with suppressing howling by reducing the overall gain, the present application only performs notch filtering on the frequency point at which howling actually occurs, and does not perform unnecessary energy adjustment to the audio signal of other frequency points, which further protects the authenticity of the audio signal and improves user experience.

In some embodiments of the present application, the processor 104 can be further configured to control the adjustment step size of the notch frequency point of the adaptive notch filter 103 based on the energy corresponding to the current notch frequency point during the process of adaptive adjustment in steps to the notch frequency point, so that the larger the energy corresponding to the current notch frequency point, the smaller the adjustment step size. Specifically, based on the NLMS (Normalized Least Mean Square) principle, the energy corresponding to the current notch frequency point is normalized to prevent gradient noise amplification, and the larger the signal energy, the smaller the step size, until the adaptive notch filter 103 converges to an optimal notch frequency point. When the energy of the output signal of the adaptive notch filter 103 is large, a fine adjustment is performed with a smaller step size, to avoid missing the howling frequency point desired for notch filtering due to a too large step size, or generating oscillation near the notch frequency point, resulting in a reduced convergence speed or even failure to converge.

Specifically, the principle of howling suppression using the adaptive notch filter 103 and the processor 104 is as follows:

The transfer function of the adaptive notch filter 103 is shown in Formula (1):

$$H ( z ) = \frac{1 - 2 * cos ( 2 * pi * f 0 / fs ) * {Z}^{- 1} + {Z}^{- 2}}{1 - 2 * ka * cos ( 2 * pi * f 0 / fs ) * {Z}^{- 1} + {ka}^{2} * {Z}^{- 2}} , \qquad Formula ( 1 )$$

where f0 is the notch frequency point, fs is the sampling frequency, and ka is a constant used to control the bandwidth of the adaptive notch filter 103.

A specific calculation step of Formula (1) is as follows:

$$z ( n ) = x ( n ) + 2 * ka * z 0 ( n ) * z ( n - 1 ) - {ka}^{2} * z ( n - 2 ) \qquad Formula ( 2 )$$

$$tmp = z ( n ) - 2 * z 0 ( n ) * z ( n - 1 ) + z ( n - 2 ) .$$

In Formula (2), x(n) is the input signal, ytmp is the output of the adaptive notch filter 103, and z(n) is an intermediate variable associated with the output of the adaptive notch filter 103.

z0(n) is an adaptively changing notch parameter associated with the notch frequency point f0(n), and their relationship satisfies the definition of Formula (3):

$$z 0 ( n ) = cos ( 2 * pi * f 0 ( n ) / fs ) , \qquad Formula ( 3 )$$

where f0(n) is the notch frequency point of the adaptive notch filter 103 at the nth moment, and the value of z0(n) at the initial moment can be set to 1, that is, z0(0)=1, and correspondingly f0(0)=0 Hz.

The energy of z(n) can be filtered according to Formula (4):

$$Ez ( n ) = alpha * Ez ( n ) + ( 1 - alpha ) * {\vert z ( n ) \vert}^{2} , \qquad Formula ( 4 )$$

where Ez(n) is the filtered energy of z(n) corresponding to the notch frequency point f0(n) at the nth moment, alpha is the filter factor, which plays the role of smoothly filtering, and can be taken as a preset constant, for example, 0.9 in some preferred embodiments. In addition, the filtered energy corresponding to z(0) at the initial moment can be set to 0, that is, Ez(0)=0.

The processor 104 can be further configured to obtain the number of the valid data bits of the energy of z(n) corresponding to the current notch frequency point, as shown in Formula (5):

$$Ebits = Ceil ( log 2 ( Ez ( n ) ) ) . \qquad Formula ( 5 )$$

Formula (5) is used to calculate the number of valid data bits of Ez(n), which is log₂(Ez(n)), Ceil( ) represents rounding up, and what is obtained by calculating Ceil(log₂(Ez(n))) is the number Ebits of valid data bits of Ez(n) after rounding up.

Based on the above number of the valid data bits Ebits, the adjustment step size of the notch frequency point of the adaptive notch filter 103 is controlled by right shift operation, as shown in Formula (6):

$$mu = delta / {2}^{Ebits} = delta ≫ Ebits , \qquad Formula ( 6 )$$

where mu is the adjustment step size of the notch frequency point, delta is a preset constant associated with the convergence speed of the adaptive notch filter 103, for controlling the convergence speed. In some preferred embodiments, for example, it can be taken that delta=0.001. delta/2^{Ebits} means reducing delta to ½^{Ebits} of the original value. For a hardware circuit such as ASIC, the above division operation can be conveniently implemented by register shifting. Specifically, >> means a right shift operation, and delta>>Ebits means shifting the register storing delta to the right by bits of Ebits.

Based on Formula (5) and Formula (6), the simple and convenient shift operation of the register implemented by hardware can be used to reduce the time for the processor 104 to calculate the adjustment step size of the notch frequency point of the adaptive notch filter 103, so that, by variably and accurately controlling the adjustment step size of the notch frequency point, the adaptive notch filter 103 can converge to the desired notch frequency point (i.e. the frequency point where howling occurs) more stably without reducing the real-time performance of the notch filtering by the adaptive notch filter 103, and the accuracy and precision of the notch frequency point converged to are also higher.

In addition, while updating the notch frequency point, the notch parameter z0(n) associated with the notch frequency point should also be iteratively updated, as shown in Formula (7):

$$z 0 ( n ) = z 0 ( n - 1 ) - 4 * mu * ytmp * ( z 0 ( n - 1 ) * z ( n - 2 ) - z ( n - 1 ) ) . \qquad Formula ( 7 )$$

A saturation operation is performed on the updated result to control its value between −1 and 1, as shown in Formula (8):

$$if ( z 0 ( n ) > 1 ) \qquad Formula ( 8 ) .$$

$$z 0 ( n ) = 1 ;$$

$$if ( z 0 ( n ) < - 1 )$$

$$z 0 ( n ) = - 1 ;$$

The process of the processor 104 determining the convergence state of the adaptive notch filter 103 is as follows.

In some embodiments, the mean and variance of the notch parameter z0(n) associated with the notch frequency point can be calculated first. In some embodiments, the mean of z0(n) can be calculated using an exponential moving average, including but not limited to Formula (9):

$$z 0 m ( n ) = beta * z 0 m ( n - 1 ) + ( 1 - beta ) * z 0 ( n ) ; \qquad Formula ( 9 ) ,$$

where z0m(n) is the exponential moving average value of z0(n) at the nth moment, and correspondingly, z0m(n−1) is the exponential moving average value of z0(n) at the (n−1)th moment. Beta is a smoothing factor for adjusting the smoothness when calculating the exponential moving average value of the z0(n) sequence. Beta can be taken as a preset constant, such as 0.9 in some preferred embodiments, and z0m (0) at the initial moment can be set to 0, that is, z0m(0)=0.

The calculation Formula of the variance of the notch parameter z0(n) is shown in Formula (10):

$$z 0 v ( n ) = beta * z 0 v ( n - 1 ) + ( 1 - beta ) * \vert z 0 ( n ) - z 0 m ( n ) \vert ; \qquad Formula ( 10 ) ,$$

where z0v(n) is the variance of z0(n) at the nth moment, z0m(n) is the exponential moving average value of z0(n) at the nth moment, and correspondingly, z0v(n−1) is the variance of z0(n) at the (n−1)th moment, beta is a smoothing factor for adjusting the smoothness when calculating z0v(n), beta can be taken as a preset constant, such as 0.9 in some preferred embodiments, and z0v (0) at the initial moment can be set to 0, that is, z0v (0)=0.

When calculating the mean and variance of z0(n) according to the above Formulas (9) and (10), only the data at the current nth moment and (n−1)th moment are used, and there is no need to store data at other historical moments, which can reduce the requirement for hardware and meanwhile further improve the processing speed of hardware-based operations.

Next, the processor 104 can use the calculated z0m(n) and z0v(n) to determine the convergence state of the adaptive notch filter 103 and the output process of the output module as shown in Formula (11):

```
      if (z0m(n) > thd1)&&(z0m(n) < thd2)&&(z0v(n) < thd3)
        st(n) = 1;
      elseif((z0v(n) > thd4) || (z0m(n) < thd1) || (z0m(n) > thd2))
        st(n) = 0;
      else
        st(n) = st(n − 1);
    if (st(n) == 1)
    a. y(n)=ytmp;
  else
```

| | |
|---|---|
| y(n)=x(n); | Formula (11), |

where ytmp is the output of the adaptive notch filter 103, x(n) is the input signal, y(n) is the output of the howling suppression system 100, st(n) represents the convergence state of the adaptive notch filter 103, and the value at the initial moment can be set to 0, that is, st(0)=0. It can be obtained from Formula (11) that at the nth moment, if the mean z0m(n) of z0(n) falls within the preset range between thd1 and thd2, and the variance z0v(n) of z0(n) is less than the first threshold thd3, it can be determined that the adaptive notch filter 103 has converged to the desired notch frequency point, and st(n) is set to 1 at this time. When st(n) is 1, the audio signal ytmp that has been notch-filtered by the adaptive notch filter 103 taking the current notch frequency point as the howling frequency point is used as the output y(n) of the ANC/PSAP system. If the variance z0v(n) of z0(n) is greater than the second threshold thd4, or z0m(n) is not within the preset range, it is considered that the adaptive notch filter 103 has not converged, and st(n) is set to 0. When st(n) is 0, the input signal x(n) that has not been notch-filtered by the adaptive notch filter 103 is used as the output y(n) of the ANC/PSAP system. In some embodiments, the first threshold thd3 is less than the second threshold thd4. In this way, setting the second threshold thd4 and the first threshold thd3 to different values is conducive to reducing the number of switching between the converged state and the non-converged state when the ANC/PSAP system outputs, and is conducive to causing the system quickly and stably converge to a more accurate notch frequency point with the occurrence of howling. In addition, when the variance z0v(n) of z0(n) is between thd3 and thd4, the state of st(n) remains unchanged. The output ytmp of the adaptive notch filter 103 is switched according to the value of st(n), which can avoid frequent output switching.

In some embodiments of the present application, the adaptive notch filter 103 is connected with at least one fixed notch filter in a cascade manner. The at least one fixed notch filter performs a second notch filtering on the howling frequency point when the adaptive notch filter 103 is in a convergence state. In some embodiments, when the signal amplitude at the howling frequency point is high and the energy is large, the energy of the howling may not be completely suppressed by only using a first-stage notch filter. Therefore, at least one fixed notch filter can be cascaded in the post-stage of the adaptive notch filter 103, to further perform a fixed frequency point notch filtering on the howling frequency point estimated by the adaptive notch filter 103, thereby enhancing the suppression effect on the howling frequency.

As an example only, when the adaptive notch filter 103 is connected with two fixed notch filters in a cascade manner, the specific implementation is shown in Formula (12):

```
if (st(n) == 1)
  y1(n) = ytmp + 2 * ka * z0(n) * y1(n − 1) − ka² * y1(n − 2)
  ytmp = y1(n) − 2 * z0(n) * y1(n − 1) + y1(n − 2)
```

| | |
|---|---|
| y2(n) = ytmp + 2 * ka * z0(n) * y2(n − 1) − ka² * y2(n − 2) | Formula (12), |

```
  y(n) = y2(n) − 2 * z0(n) * y2(n − 1) + y2(n − 2)
else
  y(n) = x(n);
```

where two cascaded fixed notch filters, fixed notch filter 1 and fixed notch filter 2, use the howling frequency point estimated by the adaptive notch filter 103 as the fixed notch frequency point when the adaptive notch filter 103 converges, that is, use the notch parameter z0(n) associated with the notch frequency point as their own notch parameter. y1(n) and y2(n) are the intermediate variables of the fixed notch filter 1 and the fixed notch filter 2 at the nth moment, respectively. The fixed notch filter 2 uses the output of the fixed notch filter 1 as input, performs fixed notch filtering on the same notch frequency point, and uses its output as the output y(n) of the ANC/PSAP system. When the adaptive notch filter 103 is in a non-converged state, the fixed notch filters cascaded therewith do not perform filtering processing, but uses the input signal x(n) as the output of the ANC/PSAP system directly, so that unnecessary calculations and power consumption can be avoided.

In some embodiments of the present application, when the system on chip 101 includes multiple howling suppression units 102, each howling suppression unit 102 is connected in a cascade manner to suppress multiple howling frequency points in the input audio signal in order of the corresponding energies at the howling frequency points from high to low, thereby suppressing the multiple howling frequency points. Of course, if the front-stage howling suppression unit 102 fails to detect the howling frequency point, the input audio signal is directly output and no further processing is required in the subsequent stage. Specifically, if the input audio signal includes multiple howling frequency points, the first-stage howling suppression unit 102 is used to estimate and suppress the howling frequency point with the highest energy. After that, the second-stage howling suppression unit 102 further estimates and suppress the howling frequency point with the second highest energy, and so on, thereby achieving the suppression of the multiple howling frequency points.

In some embodiments of the present application, a howling suppression method for an ANC/PSAP system is provided, comprising: adaptively adjusting to a notch frequency point in steps via an adaptive notch filter; in an input audio signal of the ANC/PSAP system, performing a first notch filtering on energy corresponding to the notch frequency point adjusted to; obtaining, via a processor, a mean and a variance of a notch parameter of the adaptive notch filter associated with the notch frequency point, and determining that the adaptive notch filter is in a convergence state and the notch frequency point is a howling frequency point when the mean of the notch parameter is within a preset range and the variance is less than a first threshold; determining that the adaptive notch filter is in a non-convergence state or that there is no howling frequency point when the mean of the notch parameter is not within the preset range and/or the variance is greater than a second threshold; when the adaptive notch filter is in the convergence state, using the audio signal with the notch frequency point having been notch-filtered by the adaptive notch filter as the output of the howling suppression system; when the adaptive notch filter is in the non-convergence state or there is no howling frequency point, using the input audio signal as the output of the howling suppression system. In this way, when howling exists in the system, the howling frequency point can be accurately notch-filtered, and when no howling exists, no notch filtering is performed to avoid signal distortion, and it is easy for the present application to realize hardware implementation at a high sampling rate.

In some embodiments of the present application, during the process of adaptive adjustment in steps to the notch frequency point, the processor controls the adjustment step size of the notch frequency point of the adaptive notch filter based on the energy corresponding to the current notch frequency point, so that the larger the energy corresponding to the current notch frequency point, the smaller the adjustment step size, so as to avoid missing the howling frequency point desired for notch filtering due to a too large step length, or generating oscillation near the notch frequency point, resulting in a reduced convergence speed or even failure to converge.

In some embodiments of the present application, the number of the valid data bits of the energy of z(n) corresponding to the current notch frequency point is obtained by the processor, as shown in Formula (5):

$$Ebits = Ceil ( log 2 ( Ez ( n ) ) ) . \qquad Formula ( 5 )$$

Formula (5) is used to calculate the number of valid data bits of Ez(n), which is log₂(Ez(n)), Ceil( ) represents rounding up, and what is obtained by calculating Ceil(log₂(Ez(n))) is the number Ebits of valid data bits of Ez(n) after rounding up.

Based on the above number of the valid data bits, Ebits, the adjustment step size of the notch frequency point of the adaptive notch filter 103 is controlled by right shift operation, as shown in Formula (6):

$$mu = delta / {2}^{Ebits} = delta ≫ Ebits , \qquad Formula ( 6 )$$

where mu is the adjustment step size of the notch frequency point, delta is a preset constant associated with the convergence speed of the adaptive notch filter, for controlling the convergence speed. In some preferred embodiments, for example, it can be taken that delta=0.001. delta/2^{Ebits} means reducing delta to ½^{Ebits} of the original value. For a hardware circuit such as ASIC, the above division operation can be conveniently implemented by register shifting. Specifically, >> means a right shift operation, and delta>>Ebits means shifting the register storing delta to the right by bits of Ebits.

Based on Formula (5) and Formula (6), the simple and convenient shift operation of the register implemented by hardware can be used to reduce the time for the processor 104 to calculate the adjustment step size of the notch frequency point of the adaptive notch filter, so that, by variably and accurately controlling the adjustment step size of the notch frequency point, the adaptive notch filter can converge to the desired notch frequency point (i.e. the frequency point where howling occurs) more stably without reducing the real-time performance of the notch filtering by the adaptive notch filter, and the accuracy and precision of the notch frequency point converged to are also higher.

In some embodiments of the present application, the adaptive notch filter is connected with at least one fixed notch filter in a cascade manner. The at least one fixed notch filter performs a second notch filtering on the howling frequency point when the adaptive notch filter is in a convergence state, so as to further suppress howling, thereby enhancing the suppression effect on the howling.

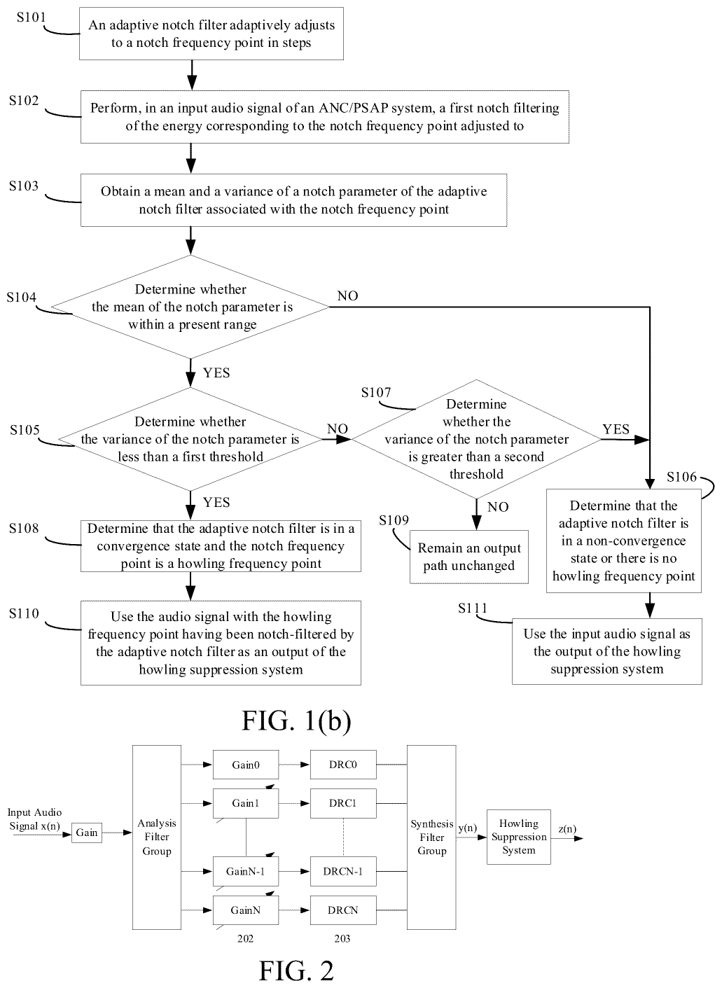

In some embodiments of the present application, a PSAP system is provided. The PSAP system includes the howling suppression system 201 described in individual embodiments of the present application. Specifically, as shown in FIG. 2, x(n) represents the input audio signal, y(n) represents the audio signal to be processed that has not passed through the howling suppression system 201, z(n) represents the actual output audio signal, each “Gain” shown in 202 is a gain, and each DRC shown in 203 is a dynamic compressor. The collected input audio signal x(n) is sent to the PSAP system, and the input audio signal x(n) is processed by the gain, analysis filter group, and synthesis filter group to form the audio signal y(n) to be processed. The howling suppression system 201 analyzes and processes the audio signal y(n) to be processed. When it is determined that the adaptive notch filter is in a convergence state, the audio signal with the howling frequency point having been notch-filtered by the adaptive notch filter is used as the output of the howling suppression system 201. At this time, z(n) is the audio signal with the howling frequency point having been notch-filtered by the adaptive notch filter. When it is determined that the adaptive notch filter is in a non-convergent state or there is no howling frequency point, the input audio signal x(n) is used as the output z(n) of the howling suppression system 201. The audio signal z(n) processed by the howling suppression system 201 is output by a speaker.

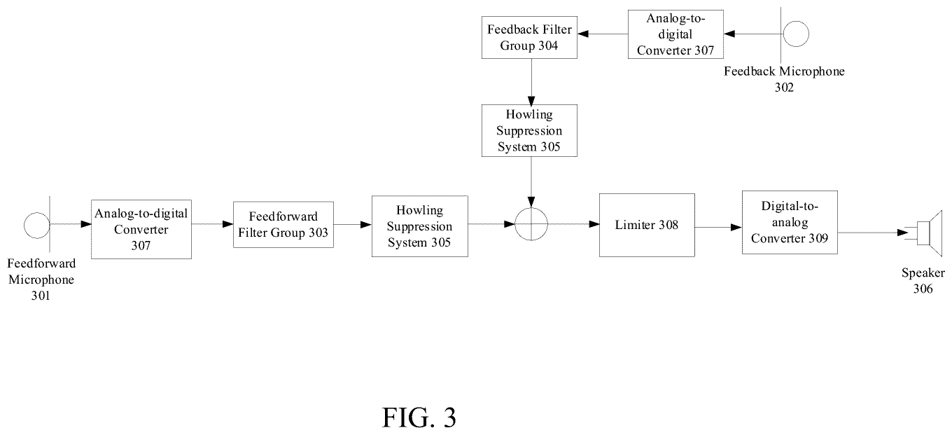

In some embodiments of the present application, an ANC system is provided. The ANC system includes the howling suppression system described in individual embodiments of the present application. Specifically, as shown in FIG. 3, the input audio signal collected by the feedforward microphone 301 and the feedback microphone 302 is sent to the ANC system, and after being converted by the analog-to-digital converter 307, it enters the feedforward filter group 303 and the feedback filter group 304 in the ANC system. The feedforward filter group 303 and the feedback filter group 304 process the input audio signal, and send the processed input audio signal to the howling suppression system 305 for howling suppression processing. The howling suppressed audio signal, after being adjusted by the limiter 398 and converted by the digital-to-analog converter 309, is output by the speaker 306. For the ANC system and the PSAP system, the delay caused by processing the howling is required to be low, and the delay of suppressing the howling is usually required to be in the microsecond or millisecond level. By adopting the howling suppression system 305, the present application can implement the howling suppression system 305 in hardware, and realize howling suppression processing at a high sampling rate (for example, a sampling rate of at least 96 k) to reduce the delay caused by howling suppression, thereby retaining the effects of the ANC system and the PSAP system themselves and improving the user experience.

In some embodiments of the present application, a computer-readable storage medium is provided having computer program instructions stored therein, wherein the computer program instructions, when executed by a processor, cause the processor to perform the howling suppression method as described in various embodiments of the present application. The implementation of such a method may include software code, such as microcode, assembly language code, high-level language code, etc. Various software programming techniques can be used to create various programs or program modules. For example, program parts or program modules can be designed with or with the aid of Java, Python, C, C++, assembly language, or any known programming language. One or more of such software parts or modules can be integrated into a computer system and/or a computer-readable medium. Such software codes may include computer-readable instructions for performing various methods. The software codes may form a part of a computer program product or a computer program module. In addition, in an example, the software codes may be tangibly stored on one or more volatile, non-temporary or non-volatile tangible computer-readable media, for example during execution or at other times. Examples of these tangible computer-readable media may include, but are not limited to, hard disks, removable disks, removable optical disks (for example, optical disks and digital video disks), cassettes, memory cards or memory sticks, random access memory (RAM), read-only memory (ROM), etc.

In addition, although exemplary embodiments have been described herein, their scope includes any and all embodiments based on the present application with equivalent elements, modifications, omissions, combinations (e.g., crossover schemes of various embodiments), adaptations or changes. The elements in the claims will be interpreted broadly based on the language adopted in the claims, and are not limited to the examples described in this specification or during the implementation of the present application, and their examples will be interpreted as non-exclusive. Therefore, this specification and examples are intended to be considered as examples only, and the true scope and spirit are indicated by the claims and the full scope of the equivalents thereof.

The above description is intended to be illustrative rather than restrictive. For example, the above examples (or one or more schemes thereof) can be used in combination with each other. For example, those of ordinary skill in the art may use other embodiments when reading the above description. In addition, in the above detailed description, various features can be grouped together to simplify the present application. This should not be interpreted as an intention that a disclosed feature that is not claimed for protection is essential to any claim. Conversely, the subject matter of the present application may include less than all the features of a particular disclosed embodiment. Thus, the claims, as examples or embodiments, are here incorporated in the detailed description, wherein each claim is presented as a separate embodiment independently, and it is contemplated that these embodiments may be combined with each other in various combinations or arrangements. The scope of the present application should be determined with reference to the appended claims and the full range of the equivalents to which these claims are entitled.

The above embodiments are only exemplary embodiments of the present application and are not intended to limit the present application. The protection scope of the present application is defined by the claims. Those skilled in the art may make various modifications or equivalent substitutions to the present application within the essence and protection scope of the present application. Such modifications or equivalent substitutions shall also be deemed to fall within the protection scope of the present application.

What is claimed is:

1. A howling suppression system for an active noise control/personal sound amplification product (ANC/PSAP) system, the howling suppression system comprising a system on chip, the system on chip configured to comprise:
at least one howling suppression unit, each of the at least one howling suppression unit comprising at least an adaptive notch filter, the adaptive notch filter adaptively adjusting to a notch frequency point in steps; in an input audio signal of the ANC/PSAP system, a first notch filtering being performed on energy corresponding to the notch frequency point adjusted to;
a processor configured to obtain a mean and a variance of a notch parameter of the adaptive notch filter associated with the notch frequency point, and determine that the adaptive notch filter is in a convergence state and the notch frequency point is a howling frequency point when the mean of the notch parameter is within a preset range and the variance is less than a first threshold; determine that the adaptive notch filter is in a non-convergence state or there is no howling frequency point when the mean of the notch parameter is not within the preset range and/or the variance is greater than a second threshold,
wherein when the adaptive notch filter is in the convergence state, the input audio signal with the howling frequency point having been notch-filtered by the adaptive notch filter is used as an output of the howling suppression system; and
when the adaptive notch filter is in the non-convergence state or there is no howling frequency point, the input audio signal is used as the output of the howling suppression system.

2. The howling suppression system according to claim 1, wherein the processor is further configured to: in a process of adaptively adjusting to the notch frequency point in steps, control an adjustment step size of the notch frequency point of the adaptive notch filter based on energy corresponding to a current notch frequency point, so that the greater the energy corresponding to the current notch frequency point, the smaller the adjustment step size.

3. The howling suppression system according to claim 2, wherein the processor is further configured to obtain a number of valid data bits of the energy corresponding to the current notch frequency point, and based on the number of the valid data bits, use a right shift operation to control the adjustment step size of the notch frequency point of the adaptive notch filter based on:
$$Ebits = Ceil ( log 2 ( Ez ( n ) ) )$$
$$mu = delta / {2}^{Ebits} = delta ≫ Ebits$$
wherein Ez(n) is energy corresponding to the notch frequency point at the nth moment, Ceil( ) indicates rounding up, Ebits is the number of valid data bits of Ez(n), mu is the adjustment step size of the notch frequency point, delta is a preset constant associated with a convergence speed of the adaptive notch filter, and delta>>Ebits indicates shifting a register storing delta to the right by bits of Ebits.

4. The howling suppression system according to claim 1, wherein the first threshold is less than the second threshold.

5. The howling suppression system according to claim 1, wherein the adaptive notch filter is connected with at least one fixed notch filter in a cascade manner, and the at least one fixed notch filter performs a second notch filtering on the howling frequency point when the adaptive notch filter is in the convergence state.

6. The howling suppression system according to claim 1, wherein when the system on chip comprises multiple howling suppression units, each howling suppression unit is connected in a cascade manner to suppress multiple howling frequency points in the input audio signal in order of the corresponding energies at the howling frequency points from high to low.

7. A howling suppression method for an active noise control/personal sound amplification product (ANC/PSAP) system, comprising:
adaptively adjusting to a notch frequency point in steps via an adaptive notch filter; in an input audio signal of the ANC/PSAP system, performing a first notch filtering on energy corresponding to the notch frequency point adjusted to;
obtaining, via a processor, a mean and a variance of a notch parameter of the adaptive notch filter associated with the notch frequency point, and determining that the adaptive notch filter is in a convergence state and the notch frequency point is a howling frequency point when the mean of the notch parameter is within a preset range and the variance is less than a first threshold;
determining that the adaptive notch filter is in a non-convergence state or there is no howling frequency point when the mean of the notch parameter is not within the preset range and/or the variance is greater than a second threshold;
using the input audio signal with the howling frequency point having been notch-filtered by the adaptive notch filter as an output of the ANC/PSAP system when the adaptive notch filter is in the convergence state; and
using the input audio signal as the output of the ANC/PSAP system when the adaptive notch filter is in the non-convergence state or there is no howling frequency point.

8. The howling suppression method according to claim 7, wherein adaptively adjusting to the notch frequency point in steps comprises controlling an adjustment step size of the notch frequency point of the adaptive notch filter based on energy corresponding to a current notch frequency point, so that the greater the energy corresponding to the current notch frequency point, the smaller the adjustment step size.

9. The howling suppression method according to claim 7, further comprising obtaining, via the processor, a number of valid data bits of the energy corresponding to a current notch frequency point, and based on the number of the valid data bits, using a right shift operation to control an adjustment step size of the notch frequency point of the adaptive notch filter based on:
$$Ebits = Ceil ( log 2 ( Ez ( n ) ) )$$
$$mu = delta / {2}^{Ebits} = delta ≫ Ebits$$
wherein Ez(n) is energy corresponding to the notch frequency point at the nth moment, Ceil( ) indicates rounding up, Ebits is the number of valid data bits of Ez(n), mu is the adjustment step size of the notch frequency point, delta is a preset constant associated with a convergence speed of the adaptive notch filter, and delta>>Ebits indicates shifting a register storing delta to the right by bits of Ebits.

10. The howling suppression method according to claim 7, wherein the adaptive notch filter is connected with at least one fixed notch filter in a cascade manner, and the at least one fixed notch filter performs a second notch filtering on the howling frequency point when the adaptive notch filter is in the convergence state.

11. The howling suppression method according to claim 7, wherein the first threshold is less than the second threshold.

12. A computer-readable storage medium comprising computer program instructions stored thereon, wherein the computer program instructions, when executed by a processor, cause the processor to perform the following method:
adaptively adjusting to a notch frequency point in steps via an adaptive notch filter; in an input audio signal of an active noise control/personal sound amplification product (ANC/PSAP) system, performing a first notch filtering on energy corresponding to the notch frequency point adjusted to;
obtaining, via a processor, a mean and a variance of a notch parameter of the adaptive notch filter associated with the notch frequency point, and determining that the adaptive notch filter is in a convergence state and the notch frequency point is a howling frequency point when the mean of the notch parameter is within a preset range and the variance is less than a first threshold; determining that the adaptive notch filter is in a non-convergence state or there is no howling frequency point when the mean of the notch parameter is not within the preset range and/or the variance is greater than a second threshold;
using the input audio signal with the howling frequency point having been notch-filtered by the adaptive notch filter as an output of the ANC/PSAP system when the adaptive notch filter is in the convergence state; and
using the input audio signal as the output of the ANC/PSAP system when the adaptive notch filter is in the non-convergence state or there is no howling frequency point.

13. The computer-readable storage medium according to claim 12, wherein in a process of adaptively adjusting to the notch frequency point in steps, the processor controls an adjustment step size of the notch frequency point of the adaptive notch filter based on energy corresponding to a current notch frequency point, so that the greater the energy corresponding to the current notch frequency point, the smaller the adjustment step size.

14. The computer-readable storage medium according to claim 12, wherein the method further comprises: obtaining, via the processor, a number of valid data bits of the energy corresponding to a current notch frequency point, and based on the number of the valid data bits, using a right shift operation to control an adjustment step size of the notch frequency point of the adaptive notch filter based on:
$$Ebits = Ceil ( log 2 ( Ez ( n ) ) )$$
$$mu = delta / {2}^{Ebits} = delta ≫ Ebits$$
wherein Ez(n) is energy corresponding to the notch frequency point at the nth moment, Ceil( ) indicates rounding up, Ebits is the number of valid data bits of Ez(n), mu is an adjustment step size of the notch frequency point, delta is a preset constant associated with a convergence speed of the adaptive notch filter, and delta>>Ebits indicates shifting a register storing delta to the right by bits of Ebits.

15. The computer-readable storage medium according to claim 12, wherein the adaptive notch filter is connected with at least one fixed notch filter in a cascade manner, and the at least one fixed notch filter performs a second notch filtering on the howling frequency point when the adaptive notch filter is in the convergence state.

16. The howling suppression method according to claim 12, wherein the first threshold is less than the second threshold.
